(19) United States
(12) Patent Application Publication
(10) Pub. No.: US 2003/0145625 A1
(43) Pub. Date: Aug. 7, 2003

(54) Method of making a glass ornament with a colorful cracked internal portion

(76) Inventor: Ching-Ming Chen, Hsin-Tien City (TW)

Correspondence Address: Ching-Ming Chen, P.O. Box No.6-57, Chung-Ho, Taipei 235, TW

(21) Appl. No.: 10/060,359

(22) Filed: Feb. 1, 2002

(51) Int. Cl. C03B 27/00

(52) U.S. Cl. 65/45

(57) ABSTRACT

A method of making a glass ornament with a colorful cracked internal portion mainly fires a pure and transparent raw material as well as a colorful raw material to soften at 1500-1600° C. and at 600-700° C. respectively for different lengths of time; then the fired and softened colorful raw material is cut into small chunks to be wrapped inside the transparent raw material so as to form natural cracks through physical changes between the softness and the hardness; the cracked product is then shaped into molds; after being kept warm for about 5-6 minutes, a transparent ornament with colorful cracked internal portion is accomplished.

### BACKGROUND OF THE INVENTION

1) Field of the Invention

The present invention relates to a method of making a glass ornament with a colorful cracked internal portion, more especially to a method of making the internal portion crack but the surface remain crackless for enhancing the decorative and visional effect of a glass ornament.

2) Description of the Prior Art

Accordingly, since a glass ornament possesses the visional sense of crystal clearness, it has been favored by the consumers for a long time; however, a conventional glass ornament, as shown in FIG. 1 of its pictorial and schematic drawing, is made by firing the transparent raw material to soften first, then shaping it into glass ornaments (1) in different molds, such as figures of people, animals or other objects; with only transparently and brilliantly visional senses, the looks of these kinds of glass ornaments (1) are boring and unable to create any variation by themselves; that is very uninteresting and fails to increase the effect of interior decoration; the need of industrial improvement motivates the design of the present invention.

### SUMMARY OF THE INVENTION

Therefore, the primary objective of the present invention is to provide a method of making a certain degree of colorful cracks inside a glass ornament while the surface thereon remains crackless so as to enhance the visional sense and the value of the glass ornament.

In the abovementioned method, a pure and transparent raw material is fired to soften at 1500-1600° C. and the colorful raw material is fired to soften at 600-700° C.; during the firing and softening procedures, the fired and softened colorful raw material is kept warm at 100-200° C. for about 5-6 minutes in order to wait for the transparent raw material to be fired to soften.

Then, in the abovementioned method, the fired and softened the colorful raw material is wrapped inside the fired and softened the transparent raw material thereby to cause physical change between the softness and the hardness so as to form colorful and natural cracks.

Finally, in the abovementioned method, the product formed with natural cracks is shaped into mold to be kept warm for about 5-6 minutes thereby to accomplish a transparent glass ornament with a colorful cracked internal portion.

To enable a further understanding of the structural features and the innovation of the present invention, the brief description of the drawings below is followed by the detailed description of the preferred embodiment.

### BRIEF DESCRIPTION OF THE DRAWINGS

FIG. 1 is a pictorial and schematic drawing of a conventional glass ornament.

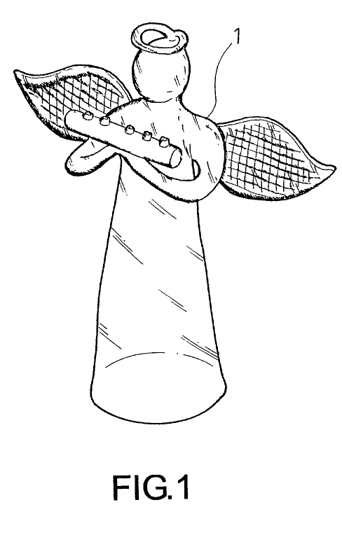

FIG. 2 is a flow chart of making the present invention.

FIG. 3 is a pictorial and schematic drawing of a glass ornament of the present invention.

FIG. 4 is a pictorial and schematic drawing of an exemplary embodiment of the present invention of a glass ornament in application.

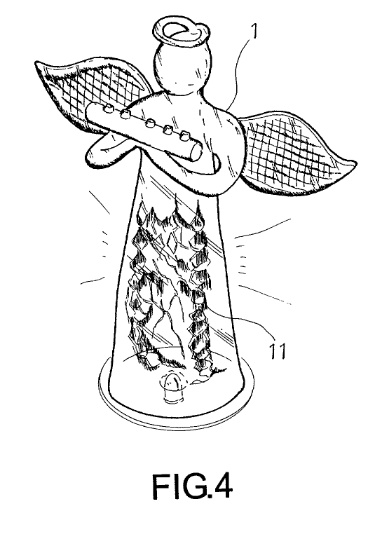

### DETAILED DESCRIPTION OF THE PREFERRED EMBODIMENTS

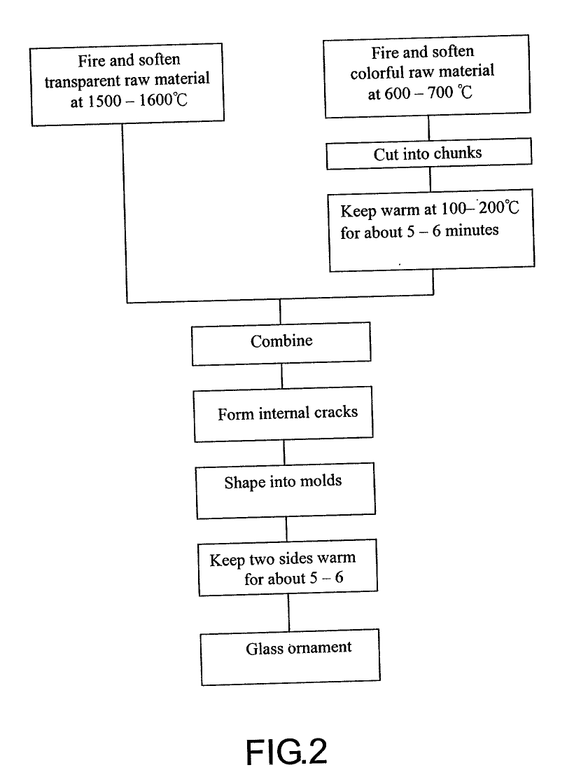

Referring to FIG. 2, as the flow chart of making the present invention, the method of making the present invention mainly includes the following steps:

1. Fire and soften a pure and transparent raw material at 1500-1600° C. and a colorful raw material at 600-700° C.

2. Cut the fired and softened colorful raw material into small chunks and keep them warm at 100-200° C. for about 5-6 minutes in order to wait for the transparent raw material to be fired to soften.

3. Wrap the colorful raw material inside the fired and softened the transparent raw material thereby to cause physical change between the softness and the hardness so as to form colorful and natural cracks and then shape the wrapped product into a mold.

4. Repetitively keep the two sides of the shaped mold warm for about 5-6 minutes so as to accomplish a glass ornament with a colorful cracked internal portion.

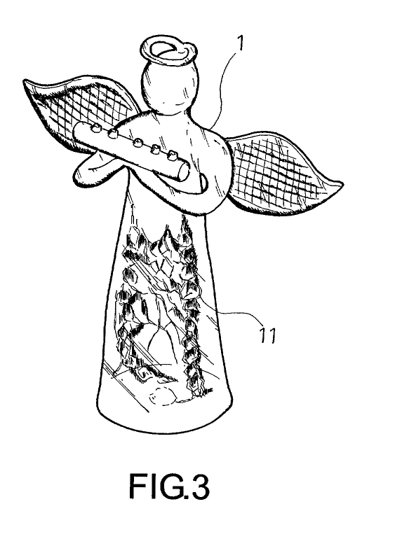

By virtue of the abovementioned manufacturing flow, the raw material of the glass is made into a glass ornament (1) as shown in FIG. 3, with colorful cracks (11) generated inside the glass ornament (1) while the surface thereon remains crackless; the visional effect produced by the cracks (11) on the internal portion enhances the valuable and the decorative effect of the glass ornament (1).

Referring to FIG. 2, the pictorial and schematic drawing of an exemplary embodiment of the present invention in application, a luminous element (a light bulb or a luminous diode) is disposed on the bottom of the finished glass ornament (1) to allow the light source projecting upwardly to refract while the light rays pass through the cracks (11) inside the glass ornament (1); therefore, the refracted light is presented translucently by the said glass ornament (1) to compose a visional sense of crystal clearness.

In summation of the abovementioned, the present invention firing and softening the transparent and the colorful raw materials through different procedures first, then wrapping the colorful raw material inside the transparent raw material to cause physical change between the softness and the hardness to generate internal cracks so as to enhance the valuable quality of the glass ornament is indeed a practical invention; it is also, of course, to be understood that the embodiment described herein is merely illustrative of the principles of the invention and that a wide variety of modifications thereto may be effected by persons skilled in the art without departing from the spirit and scope of the invention as set forth in the following claims.

1. The method of making a glass ornament with a colorful cracked internal portion includes the following steps:
fire and soften a pure and transparent raw material at 1500-1600° C. and a colorful raw material at 600-700° C.;
cut the fired and softened colorful raw material into small chunks and keep them warm at 100-200° C. for about 5-6 minutes in order to wait for the transparent raw material to be fired to soften;
wrap the colorful raw material inside the fired and softened transparent raw material thereby to cause physical change between the softness and the hardness so as to form colorful and natural cracks and then shape the wrapped product into a mold;
repetitively keep the two sides of the shaped mold warm for about 5-6 minutes so as to accomplish a glass ornament with a colorful cracked internal portion.
